(19) United States
(12) Patent Application Publication
(10) Pub. No.: US 2025/0323877 A1
(43) Pub. Date: Oct. 16, 2025

(54) CAPACITY-AWARE RESOURCE MANAGEMENT FOR CLOUD DATA PLATFORMS

(71) Applicant: Snowflake Inc., Bozeman, MT (US)

(72) Inventors: Ugur Adiguezel, Berlin (DE); Roman Borisov, Berlin (DE)

(21) Appl. No.: 18/634,440

(22) Filed: Apr. 12, 2024

(51) Int. Cl. H04L 47/70; H04L 47/74

(52) U.S. Cl. CPC H04L 47/822; H04L 47/745

(57) ABSTRACT

An assignment of a resource for a service to a compute node in a compute cluster is evaluated. The evaluating of the assignment includes determining one or more capacity consumption metrics associated with compute capacity consumed by the resource and determining one or more available capacity metrics associated with the compute node. The one or more capacity consumption metrics are compared with the one or more available capacity metrics to determine whether the compute node has available capacity for the assignment of the resource. A determination whether to confirm the assignment of the resource to the compute node is made based on the evaluating.

### TECHNICAL FIELD

Embodiments of the disclosure relate generally to cloud data platforms and, more specifically, to compute capacity-aware resource management in cloud data platforms.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

A data platform may store database data (e.g., a table) in multiple storage units, which may be referred to as partitions, micro-partitions, and/or by one or more other names. A database may be organized as records (e.g., rows or a collection of rows) that each include one or more attributes (e.g., columns). In an example, multiple storage units of a database can be stored in a block and multiple blocks can be grouped into a single file. That is, a database can be organized into a set of files where each file includes a set of blocks, where each block includes a set of more granular storage units such as partitions. It should be understood that the terms “row” and “column” are used for illustration purposes and these terms are interchangeable. For example, data arranged in a column of a table can similarly be arranged in a row of the table.

Users and/or executing processes that are associated with a given customer account may, via one or more types of clients, be able to cause data to be ingested into the database, and may also be able to manipulate the data, add additional data, remove data, run queries against the data, generate views of the data, and so forth.

When certain information is to be extracted from a database, a query statement may be executed against the database data. A data platform may process the query and return certain data according to one or more query predicates that indicate what information should be returned by the query. The data platform extracts specific data from the database and formats that data into a readable form.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a cloud data platform, in accordance with some embodiments of the present disclosure.

FIG. 2 is a block diagram illustrating components of a compute service manager of the cloud data platform, in accordance with some embodiments of the present disclosure.

FIG. 3 is a conceptual diagram illustrating a graphical representation of capacity-aware resource management in the cloud data platform, in accordance with some embodiments of the present disclosure.

FIGS. 4-7 are flow diagrams illustrating operations of the cloud data platform in performing a method for capacity-aware resource management, in accordance with some embodiments of the present disclosure.

FIG. 8 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are set forth in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Services within a data platform require the allocation of various compute capacities, which can include memory, storage, computational threads, and other compute capacities. A “service” as used herein refers to a modular software component that provides a set of related and reusable functionalities. Each service may have one or more resources. A “resource” as used herein refers to a stateful entity managed by a service and utilized in providing one or more functionalities of the service. Each such resource utilizes at least a portion of the compute capacities allocated to the service. Resources for each service are typically distributed across a cluster of compute nodes. In conventional approaches to managing service resources in a data platform, resources are allocated to nodes within a cluster in a round-robin fashion without considering the individual capacity constraints of each node. As a result, nodes may become overloaded, potentially causing system inefficiencies or failures.

Other approaches to service resource management include utilization of a load rebalancer to maintain an even distribution of resource counts across nodes. However, this approach is naively limited as it only considers the quantity of resources, not their qualitative demands or the capacity constraints of the nodes. Consequently, nodes can become temporarily overloaded, leading to inefficiencies and potential service disruptions.

Some other approaches to resource management involve implementing dedicated control planes that manage distributed state and resource allocation across large clusters. These systems often rely on centralized components to maintain capacity information and make scheduling decisions, which may not be appropriate for smaller cluster architectures.

Aspects of the present disclosure include a data platform, systems, methods, and devices that improve upon conventional resource management techniques with a capacity-aware resource management system that can operate effectively within a multi-tenant cluster environment, where independent services with varying capacity demands coexist on the same infrastructure. The capacity-aware resource management system manages resource assignments when resources are assigned to compute nodes when the resources first appear in the system as well as when nodes are selected as resource transfer targets by the system.

In an example, an assignment of a resource of a service to a compute node in a compute cluster is evaluated by the compute node based on a comparison of capacity consumption information for the resource and available capacity information for the compute node. The capacity consumption information includes one or more capacity consumption metrics related to compute capacity consumed by the resource (e.g., disk space, memory, computational threads, CPU utilization, network bandwidth, I/O operations per second, number of sockets) and the available capacity information includes one or more available capacity metrics related to available compute capacity of the compute node. The compute node obtains the capacity consumption information via an Application Programming Interface (API) from the service. The compute capacity consumption information can include estimations of capacity consumption metrics, observed capacity consumption metrics based on actual capacity consumption of the resource, or various combinations of both.

The compute node compares the one or more capacity consumption metrics with the one or more available capacity metrics to determine whether the compute node has available capacity for the resource. If the compute node determines it has available capacity for the resource, the compute node confirms the assignment, and the assignment of the resource to the compute node proceeds. If the compute node determines the compute capacity consumption of the resource exceeds the available compute capacity consumption of the compute node, the assignment of the resource is rejected, and the assignment of the resource is redirected to another compute node in the compute cluster for evaluation. This process is repeated until a compute node with sufficient capacity for the resource is found.

The capacity-aware resource management system described herein allows for precise control over the placement of resources on compute nodes within a compute cluster by considering the capacity constraints of each compute node. This ensures that resources such as data repositories, data warehouses, or other stateful entities do not exceed the available capacity, such as disk space, memory, or computational threads, thereby preventing node overload and potential system failures. Preventing the over-allocation of resources to any single node in this manner contributes to the overall stability and reliability of the data platform because compute nodes are less likely to experience outages due to capacity exhaustion, which translates to a more consistent and dependable service for end-users.

Managing resources based on capacity metrics also allows for better scalability. For example, as demand grows or shrinks, the system can dynamically adjust resource allocation across the cluster to ensure optimal utilization of the infrastructure. This flexibility is useful for adapting to varying workloads without manual intervention.

In addition, the capacity-aware resource management system maintains a decentralized framework, where each compute node independently makes decisions about resource assignment. This approach avoids the complexity and potential bottlenecks associated with a centralized control plane, leading to a more resilient and scalable system.

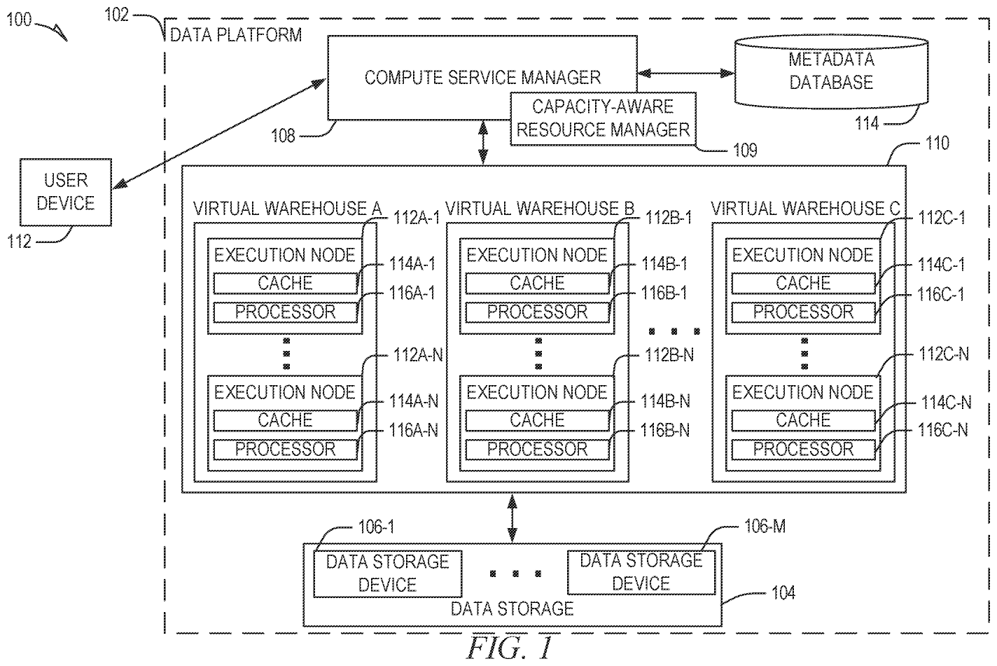

FIG. 1 illustrates an example computing environment 100 that includes a cloud data platform 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the cloud data platform 102 comprises a three-tier architecture: a compute service manager 108 coupled to a metadata database 114, an execution platform 110, and data storage 104. The cloud data platform 102 hosts and provides data access, management, reporting, and analysis services to multiple client accounts. Administrative users can create and manage identities (e.g., users, roles, and groups) and use permissions to allow or deny access to the identities to resources and services. The cloud data platform 102 is used for reporting and analysis of integrated data from one or more disparate sources including storage devices within the data storage 104. The data storage 104 comprises a plurality of computing machines and provides on-demand computer system resources such as data storage and computing power to the cloud data platform 102.

The compute service manager 108 includes multiple services that coordinate and manage operations of the cloud data platform 102. For example, the compute service manager 108 is responsible for performing query optimization and compilation as well as managing clusters of compute nodes that perform query processing (also referred to as “virtual warehouses”). The compute service manager 108 can support any number of client accounts such as end users providing data storage and retrieval requests, system administrators managing the systems and methods described herein, and other components/devices that interact with compute service manager 108.

In some implementations, each of the various services of the compute service manager 108 are run by a compute cluster. A capacity-aware resource manager 109 of the compute service manager 108 manages assignments of each service's resources to compute nodes based on capacity consumption information for each resource and available capacity information for each compute node. Further details of the operation of the compute service manager 108 are discussed below.

The compute service manager 108 is also in communication with a user device 112. The user device 112 corresponds to a user of one of the multiple client accounts supported by the cloud data platform 102. In some implementations, the compute service manager 108 does not receive any direct communications from the user device 112 and only receives communications concerning jobs from a queue within the cloud data platform 102.

The compute service manager 108 is also coupled to the metadata database 114. The metadata database 114 stores metadata pertaining to various functions and aspects associated with the cloud data platform 102 and its users. The metadata database 114 also includes a summary of data stored in data storage 104 as well as data available from local caches. Additionally, the metadata database 114 includes information regarding how data is organized in the data storage 104 and the local caches.

The compute service manager 108 is further coupled to the execution platform 110, which includes multiple virtual warehouses (computing clusters) that execute various data storage and data retrieval tasks. As an example, a set of processes on a compute node executes at least a portion of a query plan compiled by the compute service manager 108. As shown, the execution platform 110 includes virtual warehouse A, virtual warehouse B, and virtual warehouse C. Each virtual warehouse includes multiple execution nodes that each includes a data cache and a processor. For example, as shown, virtual warehouse A includes execution nodes 112A-1 to 112A-N; execution node 112A-1 includes a cache 114A-1 and a processor 116A-1; and execution node 112A-N includes a cache 114A-N and a processor 116A-N. Similarly, in this example, virtual warehouse B includes execution nodes 112B-1 to 112B-N; execution node 112B-1 includes a cache 114B-1 and a processor 116B-1; and execution node 112B-N includes a cache 114B-N and a processor 116B-N. Additionally, virtual warehouse C includes execution nodes 112C-1 to 112C-N; execution node 112C-1 includes a cache 114C-1 and a processor 116C-1; and execution node 112C-N includes a cache 114C-N and a processor 116C-N.

Each execution node of the execution platform 110 is assigned to processing one or more data storage and/or data retrieval tasks. Hence, the virtual warehouses can execute multiple tasks in parallel utilizing the multiple execution nodes. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

In some examples, the execution nodes of the execution platform 110 are stateless with respect to the data the execution nodes are caching. That is, the execution nodes do not store or otherwise maintain state information about the execution node or the data being cached by a particular execution node, in these examples. Thus, in the event of an execution node failure, the failed node can be transparently replaced by another node. Since there is no state information associated with the failed execution node, the new (replacement) execution node can easily replace the failed node without concern for recreating a particular state.

The execution platform 110 may include any number of virtual warehouses. Additionally, the number of virtual warehouses in the execution platform 110 is dynamic, such that new virtual warehouses are created when additional processing and/or caching resources are needed. Similarly, existing virtual warehouses may be deleted when the resources associated with the virtual warehouse are no longer necessary.

Although each virtual warehouse shown in FIG. 1 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary. Additionally, although the execution nodes shown in the example of FIG. 1 each include a single data cache and a single processor, in other examples, execution nodes can contain any number of processors and any number of caches. Also, the caches may vary in size among the different execution nodes.

In some examples, the virtual warehouses of the execution platform 110 operate on the same data, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Although virtual warehouses A, B, and C are illustrated with an association with the same execution platform 110, the virtual warehouses may be implemented using multiple computing systems at multiple geographic locations. For example, virtual warehouse A can be implemented by a computing system at a first geographic location, while virtual warehouses B and C are implemented by another computing system at a second geographic location. In some examples, these different computing systems are cloud-based computing systems maintained by one or more different entities.

The execution platform 110 is coupled to data storage 104. The data storage 104 comprises multiple data storage devices 106-1 to 106-M. In some embodiments, the data storage devices 106-1 to 106-M are cloud-based storage devices located in one or more geographic locations. For example, the data storage devices 106-1 to 106-M may be part of a public cloud infrastructure or a private cloud infrastructure. The data storage devices 106-1 to 106-M may be hard disk drives (HDDs), solid state drives (SSDs), storage clusters, Amazon S3™ storage systems or any other data storage technology. Additionally, the data storage 104 may include distributed file systems (e.g., Hadoop Distributed File Systems (HDFS)), object storage systems, and the like. In some examples, the storage devices 106-1 to 106-M are managed and provided by a third-party data storage platform (e.g., AWS®, Microsoft Azure Blob Storage®, or Google Cloud Storage®).

Each virtual warehouse can access any of the data storage devices 106-1 to 106-M shown in FIG. 1. Thus, the virtual warehouses are not necessarily assigned to a specific data storage device 106-1 to 106-M and, instead, can access data from any of the data storage devices 106-1 to 106-M within the data storage 104. Similarly, each of the execution nodes shown in FIG. 1 can access data from any of the data storage devices 106-1 to 106-M. In some examples, a particular virtual warehouse or a particular execution node may be temporarily assigned to a specific data storage device, but the virtual warehouse or execution node may later access data from any other data storage device.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another.

As shown in FIG. 1, the data storage devices 106-1 to 106-M are decoupled from the computing resources associated with the execution platform 110. This architecture supports dynamic changes to the cloud data platform 102 based on the changing data storage/retrieval needs as well as the changing needs of the users and systems. The support of dynamic changes allows the cloud data platform 102 to scale quickly in response to changing demands on the systems and components within the cloud data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

During typical operation, the cloud data platform 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more execution nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 108 in determining which nodes in the execution platform 110 have already cached at least a portion of the data needed to process the task. One or more nodes in the execution platform 110 process the task using data cached by the nodes and, if necessary, data retrieved from the data storage 104.

The compute service manager 108, metadata database 114, execution platform 110, and data storage 104 are shown in FIG. 1 as individual discrete components. However, each of the compute service manager 108, metadata database 114, execution platform 110, and data storage 104 may be implemented as a distributed system (e.g., distributed across multiple systems/platforms at multiple geographic locations). Additionally, each of the compute service manager 108, metadata database 114, execution platform 110, and data storage 104 can be scaled up or down (independently of one another) depending on changes to the requests received and the changing needs of the cloud data platform 102. Thus, in the described embodiments, the cloud data platform 102 is dynamic and supports regular changes to meet the current data processing needs.

As shown in FIG. 1, the computing environment 100 separates the execution platform 110 from the data storage 104. In this arrangement, the processing resources and cache resources in the execution platform 110 operate independently of the data storage devices 106-1 to 106-M in the data storage 104. Thus, the computing resources and cache resources are not restricted to specific data storage devices 106-1 to 106-M. Instead, all computing resources and all cache resources may retrieve data from, and store data to, any of the data storage resources in the data storage 104.

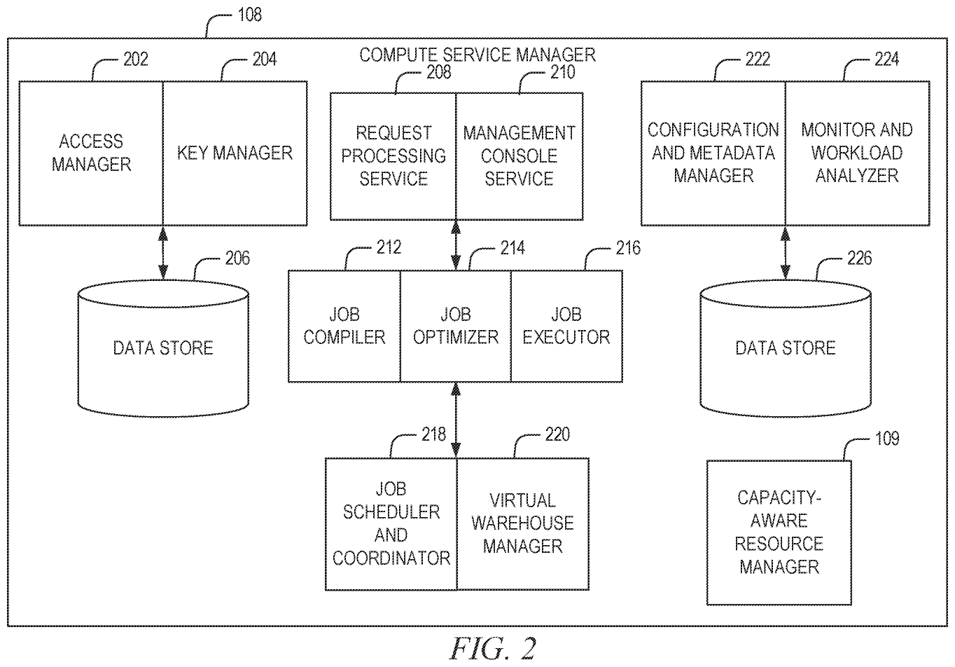

FIG. 2 is a block diagram illustrating components of the compute service manager 108, in accordance with some embodiments of the present disclosure. As shown in FIG. 2, the compute service manager 108 includes an access manager 202 and a key manager 204 coupled to a data store 206. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 104).

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 identifies or assigns particular nodes in the execution platform 110 to process particular tasks.

A virtual warehouse manager 220 manages the operation of multiple virtual warehouses implemented in the execution platform 110. As discussed below, each virtual warehouse includes multiple execution nodes that each include a cache and a processor.

Additionally, the compute service manager 108 includes a configuration and metadata manager 222, which manages the information related to the data stored in the remote data storage devices and in the local caches (e.g., the caches in execution platform 110). The configuration and metadata manager 222 uses the metadata to determine which storage units need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the cloud data platform 102 and may further redistribute tasks based on a user (e.g., “external”) query workload that may also be processed by the execution platform 110. The configuration and metadata manager 222 and the monitor and workload analyzer 224 are coupled to a data store 226. Data store 226 in FIG. 2 represents any data repository or device within the cloud data platform 102. For example, data store 226 may represent caches in execution platform 110, storage devices in data storage 104, or any other storage device.

In addition, as mentioned above, the compute service manager 108 includes a capacity-aware resource manager 109 that is responsible for assigning resources for services (e.g., any one of the other components of the compute service manager 108 described above) to compute nodes. The capacity-aware resource manager 109 assigns resources based on capacity consumption of the resources and available capacity of the compute nodes. Further details regarding the capacity-aware resource manager 109 are discussed below.

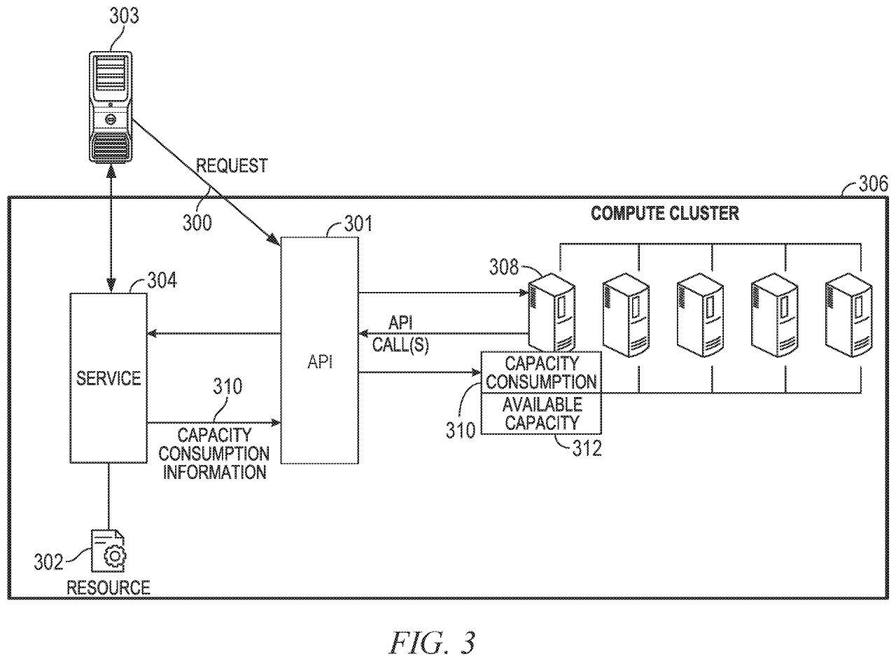

FIG. 3 is a conceptual diagram illustrating a graphical representation of capacity-aware resource management in the cloud data platform, in accordance with some embodiments of the present disclosure. As shown, a request 300 is received, via an API 301, from an initiating entity 303 to initiate assignment of a resource 302 of a service 304 (e.g., one of the components of the compute service manager 108 described above) to a compute node from compute cluster 306. An instance of the service 304 and the capacity-aware resource manager 109 runs on each compute node in the compute cluster 306. The initiating entity 303 may, for example, be a client machine (e.g., corresponding to the service 304), a rebalancer, or a resource transfer component. By way of non-limiting example, the resource 302 can be a repository, a data warehouse, a queue, a state blob or the like. In response to the request 300, the API 301 generates a resource assignment that initially directed to a compute node 308 within the compute cluster 306.

In this example, the instance of the capacity-aware resource manager 109 run by the compute node 308 evaluates the assignment of the resource 302 to determine whether to confirm or reject the assignment. The instance of the capacity-aware resource manager 109 run by the compute node 308 evaluates the assignment of the resource 302 based on a comparison of capacity consumption information 310 for the resource 302 received from the instance of the service 304 running on the compute node 308 and available capacity information 312 for the compute node 308. The instance of the capacity-aware resource manager 109 run by the compute node 308 locally stores capacity information including the capacity consumption information 310 for the resource 302 and available capacity information 312 for the compute node 308.

The capacity consumption information 310 includes one or more capacity consumption metrics associated with compute capacity consumed by the resource 302. In an example, the capacity consumption information 310 is represented as a first vector that includes the one or more capacity consumption metrics. By way of non-limiting example, the one or more capacity consumption metrics can include disk space (an amount of consumed storage space on the local file system), memory (an amount of RAM consumed), threads (a number of computational threads spawned), CPU utilization, network bandwidth (an amount of network throughput consumed), input/output (I/O) operations (performed I/O operations per second), and number of sockets. The capacity consumption information 310 can include estimated capacity consumption information (e.g., estimated capacity metrics), observed capacity consumption information (e.g., observed capacity metrics), or various combinations thereof.

The available capacity information 312 of the compute node 308 is based on configured capacity limits of the compute node 308 and the capacity consumption of other resources currently assigned to the compute node 308. The available capacity information 312 includes one or more available capacity metrics. Similar to the capacity consumption metrics, the one or more available capacity metrics can include disk space (an amount of available storage space on the local file system), memory (an amount of available RAM), threads (a number of computational threads that can be spawned), CPU capacity, network bandwidth (an amount of network throughput available), I/O operations (performable I/O operations per second), and number of available sockets. Consistent with the example referenced above, the available capacity information 312 can be represented as a second vector that includes the one or more available capacity metrics.

In evaluating the assignment of the resource 302 to the compute node 308, the instance of the capacity-aware resource manager 109 running on the compute node 308 determines whether there is available capacity for the resource 302 based on the comparison of the capacity consumption information 310 for the resource 302 and the available capacity information 312 for the compute node 308. In an example, the compute node 308 compares the first vector representing the capacity consumption metrics to the second vector representing the available capacity metrics. Consistent with this example, defined capacity metrics in the first and second vectors with unavailable values are set to zero prior to the comparison.

If the capacity-aware resource manager 109 determines there is available capacity for the resource 302 (a positive evaluation), the compute node 308 confirms the assignment of the resource 302 and the assignment to the compute node 308 proceeds.

In instances where the resource 302 is a new resource that has not previously been assigned to a compute node in the compute cluster 306, the capacity consumption information 310 used in the evaluation includes one or more estimated capacity consumption metrics. Estimated capacity metrics are obtained from the instance of the service 304 running on the compute node 308 via the API 301 (e.g., by making one or more calls to the API 301).

Once the resource 302 is assigned to the compute node 308, the instance of the service 304 running on the compute node 308 monitors capacity consumption of the resource 302 to generate the observed capacity consumption information comprising one or more observed capacity consumption metrics based on the actual (rather than estimated) capacity consumption of the resource 302. The instance of the capacity-aware resource manager 109 running on the compute node 308 obtains the observed capacity consumption information from the instance of the service 304 running on the compute node 308 via a call to the API 301 and the capacity-aware resource manager 109 uses the observed capacity consumption information to update the locally stored capacity information including the capacity consumption information 310 for the resource 302 and available capacity information 312 for the compute node 308. In addition, if the service 304 transfers the assignment of the resource 302 to another compute node, the evaluation of the assignment is performed based on a comparison of the available capacity information 312 of the compute node 308 to the observed capacity consumption information of the resource 302 rather than the estimated capacity consumption information.

If, based on the evaluation, the instance of the capacity-aware resource manager 109 run by the compute node 308 determines that the estimated capacity consumed by the resource 302 exceeds the available capacity of the compute node 308, the compute node 308 rejects the assignment of the resource 302. If the resource assignment is rejected by the compute node 308, the resource assignment is redirected to a different compute node in the compute cluster 306 and the process is repeated until a compute node with enough capacity to accommodate the resource 302 accepts the resource assignment. In an example, the resource assignment is redirected to compute nodes in the compute cluster 306 in a round-robin fashion.

Although FIG. 3 illustrates a single API 301 used in performing resource capacity control, multiple APIs may be utilized. For example, a first API may be used by the service 304 to provide the request 300 to the compute node 308, a second API may be used by the compute node 308 to obtain the estimated capacity consumption information for the resource 302 from the service 304, and a third API may be used by the compute node 308 to obtain the observed capacity consumption information for the resource 302 from the service 304.

In the example illustrated by FIG. 3 and described above, the evaluation and confirmation or rejection of the assignment of resource 302 is performed by the compute node 308 executing aspects of the capacity-aware resource manager 109. However, in other examples, a dedicated compute node in the compute cluster performs resource evaluations for all compute nodes in the compute cluster 306. Consistent with these examples, the dedicated compute node maintains capacity information including available capacity metrics for each compute node in the compute cluster and capacity consumption information for resources assigned to the compute nodes in the compute clusters. Further, the dedicated compute node, in these examples, obtains observed capacity consumption information from the service 304 via API 301.

In some examples, the dedicated compute node is further responsible for performing load rebalancing of the compute cluster 306. For example, the dedicated compute node can determine that the consumed capacity of the compute node 308 exceeds a threshold capacity consumption (a maximum safe capacity consumption) based on available capacity information for the compute node 308, which may be updated based on observed capacity consumption information for the resource 302 or another resource assigned to the compute node 308. Based on determining that the consumed capacity of the compute node 308 exceeds the threshold, the dedicated compute node reassigns one or more resources assigned to the compute node 308 to one or more other compute nodes in the compute cluster 306. For example, the resource 302 may be transferred from the compute node 308 to another compute node in the cluster 306 based on determining that the other compute node has available capacity for the resource 302 in view of the capacity consumption information for the resource 302 and available capacity information for the other compute node.

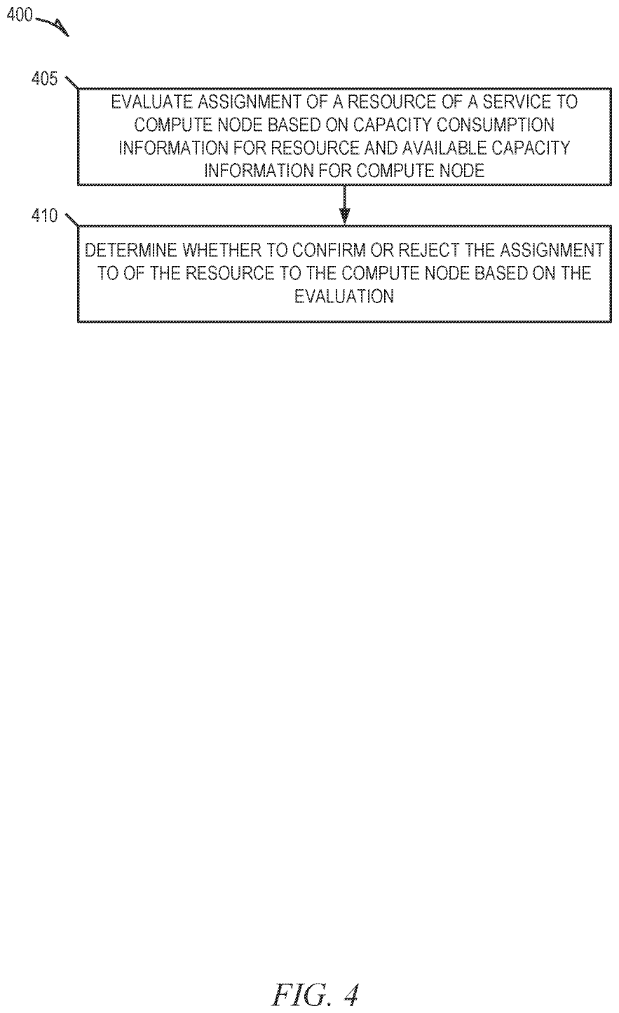

FIGS. 4-7 are flow diagrams illustrating operations of the cloud data platform in performing a method for capacity-aware resource management, in accordance with some embodiments of the present disclosure. The method 400 may be embodied in computer-readable instructions for execution by one or more hardware components (e.g., one or more processors) such that the operations of the method 400 may be performed by components of cloud data platform 102. Accordingly, the method 400 is described below, by way of example with reference thereto. However, it shall be appreciated that the method 400 may be deployed on various other hardware configurations and is not intended to be limited to deployment within the cloud data platform 102.

Depending on the embodiment, an operation of the method 400 may be repeated in different ways or involve intervening operations not shown. Though the operations of the method 400 may be depicted and described in a certain order, the order in which the operations are performed may vary among embodiments, including performing certain operations in parallel or performing sets of operations in separate processes or separate threads.

At operation 405, the capacity-aware resource manager 109 evaluates an assignment of a resource for a service to a compute node in a compute cluster. In an example, the service is a component of the compute service manager 108 and is deployed on each node of the compute cluster. As will be discussed in further detail below, the capacity-aware resource manager 109 evaluates the assignment of the resource to the compute node based on a comparison of one or more capacity consumption metrics associated with compute capacity consumed by the resource and one or more available capacity metrics associated with the compute node.

In an example, a first vector represents the capacity consumption metrics and a second vector represents the available capacity metrics. Consistent with this example, the capacity-aware resource manager 109 compares the first vector representing the capacity consumption metrics to the second vector representing the available capacity metrics to determine whether there is available capacity in the compute node for the resource.

At operation 410, the capacity-aware resource manager 109 determines whether to confirm or reject the assignment of the resource to the compute node based on the evaluation performed at operation 405.

In some examples, resource assignments are evaluated in a round-robin manner among compute nodes in the compute cluster. That is, a given resource assignment is evaluated for a first compute node in the compute cluster, and if the resource assignment to the first compute node is rejected based on the evaluation, the resource assignment is evaluated for a second compute node in the compute cluster selected based on a round-robin scheme. If the resource assignment to the second compute node is rejected, the evaluation of the resource assignment is performed with respect to a third compute node selected based on the round-robin scheme, and the process is continued until a positive evaluation is reached with respect to one of the compute nodes in the compute cluster. If the resource assignment is rejected by all compute nodes in the compute cluster, an error occurs and an error message is provided. In some examples, the process is repeated for up to a configurable number of attempts (e.g., smaller than the number of nodes in the cluster) and if the number of attempts fail, an error occurs.

In some examples, the evaluation and confirmation or rejection of the resource assignment by the capacity-aware resource manager 109 is executed by the compute node. Consistent with these examples, the compute node itself performs the evaluation of the resource assignment and determines whether to confirm or reject the resource assignment based on locally stored capacity information.

In some examples, the capacity-aware resource manager 109 is executed by a dedicated compute node in the compute cluster that is responsible for performing resource evaluations for all compute nodes in the compute cluster. Consistent with these examples, the dedicated compute node maintains capacity information including available capacity metrics for each compute node in the compute cluster.

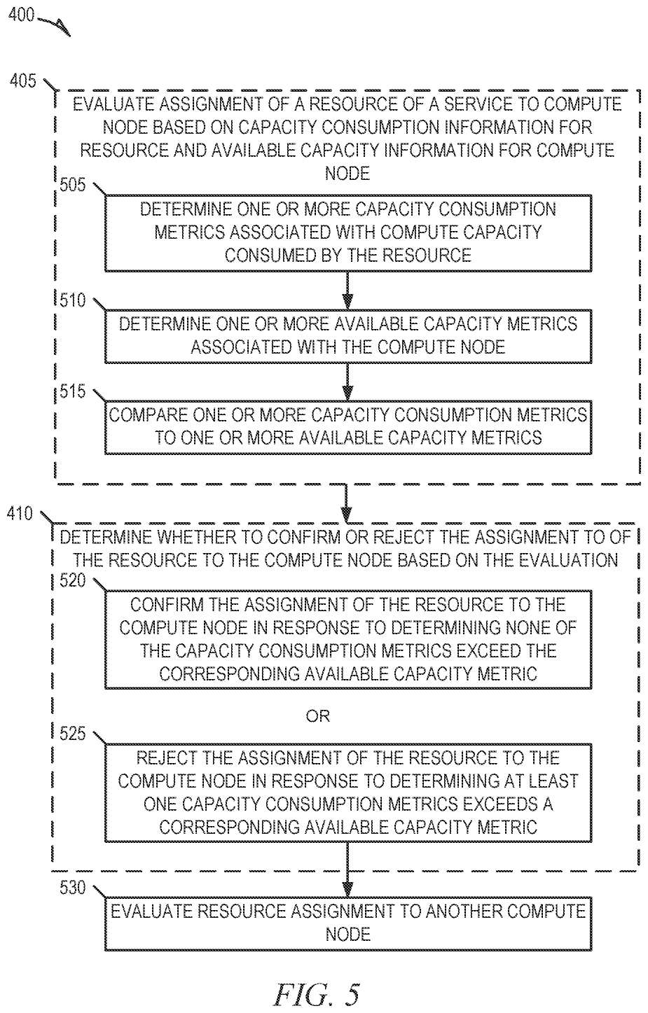

As shown in FIG. 5, the method 400 may include operations 505, 510, 515, 520, 525, and 530 in some examples. Consistent with these examples, the operations 505, 510, and 515 may be performed as part of the operation 405 where the capacity-aware resource manager 109 performs the evaluation of the resource assignment to the compute node.

At operation 505, the capacity-aware resource manager 109 determines one or more capacity consumption metrics (e.g., amount of disk space consumed, amount of memory consumed, number of threads consumed, CPU utilization, network bandwidth utilization, performed I/O operations/second, number of sockets used) associated with compute capacity consumed by the resource. The one or more capacity consumption metrics can include one or more estimated capacity consumption metrics and/or one or more observed capacity metrics. In an example, the capacity-aware resource manager 109 determines the one or more capacity consumption metrics by performing one or more API calls (e.g., the API 301) to obtain the one or more capacity consumption metrics from the service. In another example, the capacity-aware resource manager 109 determines the one or more capacity consumption metrics by accessing capacity information stored locally by the compute node.

At operation 510, the capacity-aware resource manager 109 determines one or more available capacity metrics associated with the compute node (e.g., an amount of available storage space on the local file system, an amount of available memory, a number of spawnable computational threads, CPU capacity, available network bandwidth, i/o operations per second that can be performed, and number of available sockets). Available capacity metric values are stored locally as part of the capacity information stored by the compute node. Thus, in some examples, the capacity-aware resource manager 109 determines the one or more available capacity metrics associated with the compute node by accessing the locally stored capacity information.

At operation 515, the capacity-aware resource manager 109 compares the one or more capacity consumption metrics with the one or more available capacity metrics to determine whether the compute node has sufficient capacity for the resource assignment. In an example of the comparison, the capacity-aware resource manager 109 compares each capacity consumption metric with the corresponding available capacity metric to determine whether the capacity consumption metric exceeds the available capacity metric. As a more detailed example, the capacity-aware resource manager 109 compares the disk space consumption of the resource with the available disk space of the compute node to determine whether the disk space consumption of the resource exceeds the available disk space of the compute node. As another example, the capacity-aware resource manager 109 compares the memory utilization of the resource with the available memory of the compute node to determine whether the memory utilization of the resource exceeds the available memory of the compute node. As yet another example, the capacity-aware resource manager 109 compares the CPU utilization of the resource with the CPU capacity of the compute node to determine whether the CPU utilization of the resource exceeds the CPU capacity of the compute node.

Consistent with these examples, operation 520 or operation 525 may be performed as part of the operation 410 where the capacity-aware resource manager 109 determines whether to confirm or reject the resource assignment.

At operation 520, the capacity-aware resource manager 109 confirms the assignment of the resource to the compute node in response to determining none of the capacity consumption metrics exceed any of the corresponding available capacity metrics of the compute node (a positive evaluation).

In the alternative, if the capacity-aware resource manager 109 determines that at least one capacity consumption metric exceeds a corresponding available capacity metric (a negative evaluation), the capacity-aware resource manager 109 rejects the assignment of the resource to the compute node, at operation 525. Based on the resource assignment to the compute node being rejected, the method 400 proceeds to operation 530 where the resource assignment is evaluated for a second compute node (referenced as “another compute node” in FIG. 5) in the compute cluster based on the one or more capacity consumption metrics associated with compute capacity consumed by the resource and capacity information associated with the second compute node.

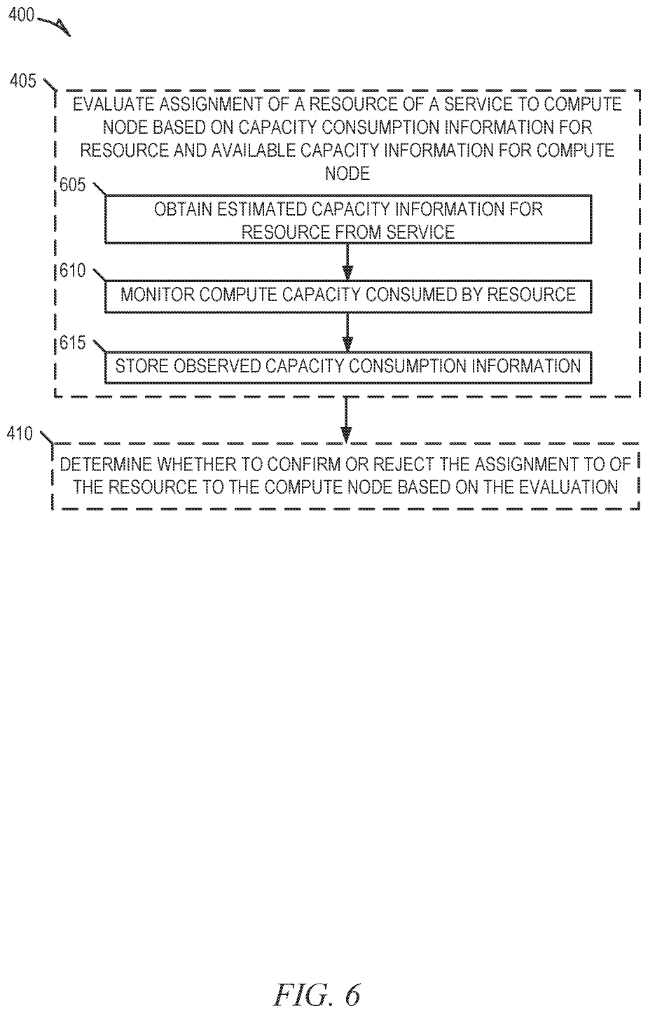

As shown in FIG. 6, the method 400, in some examples, includes operations 605, 610, and 615. Consistent with these examples, the operations 605, 610, and 615 are performed prior to or as part of the operation 405 where the capacity-aware resource manager 109 evaluates the assignment of the resource to the compute node.

At operation 605, the capacity-aware resource manager 109 obtains estimated capacity information for the resource from the service. The estimated capacity information includes one or more estimated capacity consumption metrics for the resource. In an example, the capacity-aware resource manager 109 obtains the estimated capacity information by performing one or more calls to a first API (e.g., API 301) configured for obtaining estimated capacity information from the service.

As noted above, in some examples, the capacity-aware resource manager 109 determines the one or more capacity consumption metrics associated with compute capacity consumed by the resource at least based in part on the estimated capacity information. That is, one or more of the capacity consumption metrics used in evaluating the resource assignment to the compute node may include one or more estimated capacity metrics.

At operation 610, the capacity-aware resource manager 109 monitors the compute capacity consumed by the resource and the capacity-aware resource manager 109 stores observed capacity information for the resource determined based on the monitoring, at operation 615. In some examples, the monitoring of the compute capacity consumed by the resource includes periodically surveying the service for observed compute capacity information for the resource. That is, in these examples, the capacity-aware resource manager 109 periodically submits calls to a second API (e.g., to the API 301) configured for obtaining observed compute capacity information from the service.

As noted above, in some examples, the capacity-aware resource manager 109 determines the one or more capacity consumption metrics associated with compute capacity consumed by the resource at least based in part on the observed capacity information.

In some examples, the capacity-aware resource manager 109 monitors the compute capacity consumed by the resource when the resource is assigned to another compute node in the compute cluster and the observed capacity information is provided to the compute node for which the current resource assignment is being evaluated.

In some examples, the capacity-aware resource manager 109 determines the one or more capacity consumption metrics based on various combinations of the estimated and observed capacity information. In a first example, the capacity-aware resource manager 109 determines multiple capacity consumption metrics associated with the resource where a first portion of the capacity metrics are based on the estimated capacity information and a second portion of the capacity metrics are based on the observed capacity information. In a second example, the capacity-aware resource manager 109 may initially determine a capacity metric based on the estimated capacity information and the capacity-aware resource manager 109 may subsequently modify the capacity metric based on the observed capacity information.

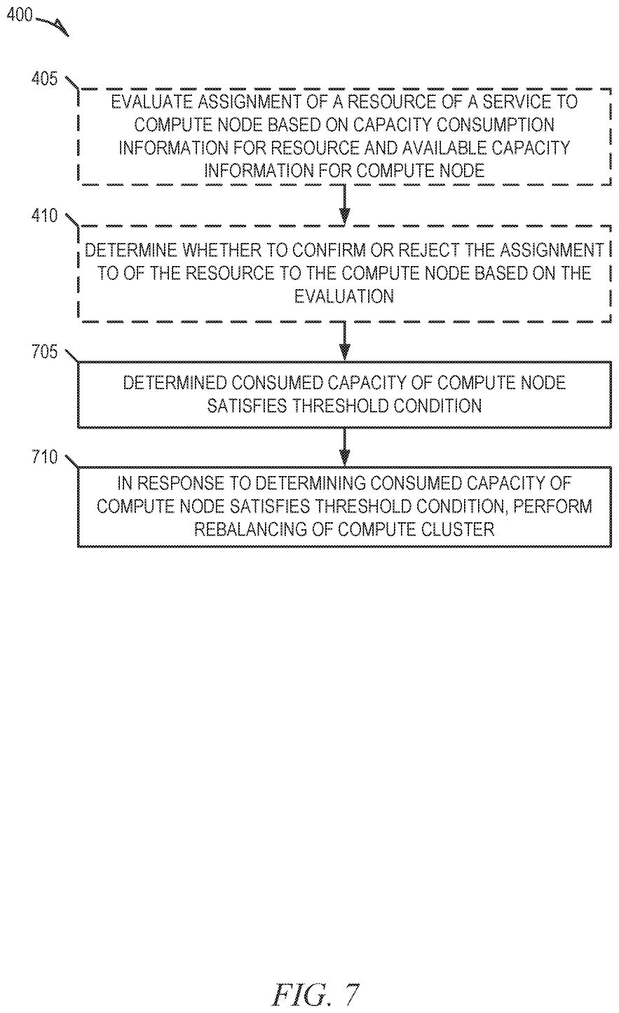

As shown in FIG. 7, the method 400, in some examples, includes operations 705 and 710. Consistent with these examples, the operations 705 and 710 are performed subsequent to confirming assignment of the resource to the compute node (operation 410). At operation 705, the capacity-aware resource manager 109 determines whether a consumed capacity of the compute node satisfies a threshold condition. In an example, the threshold condition defines a maximum capacity consumption for the compute node. The maximum capacity consumption comprises one or more predefined values associated with the available capacity metrics of the compute node. Consistent with this example, the capacity-aware resource manager 109 determines that the consumed capacity of the compute node satisfies the threshold condition based on the consumed capacity of the compute node exceeding the maximum capacity consumption. The capacity-aware resource manager 109 determines the consumed capacity for the compute node based on capacity information that is updated based on observed capacity consumption of resources assigned to the compute node. That is, the capacity-aware resource manager 109 may determine that the threshold condition for capacity consumption of the compute node is satisfied based on updated observed capacity consumption information for the resource or another resource assigned to the compute node.

Based on determining the consumed capacity of the compute node satisfies the threshold condition, the capacity-aware resource manager 109 (running on a dedicated compute node), at operation 710, performs a rebalancing of the compute cluster. In rebalancing the compute cluster, the capacity-aware resource manager 109 reassigns one or more resources assigned to the compute node to one or more other compute nodes in the compute cluster. For example, the capacity-aware resource manager 109 may reassign the resource from the compute node to a second compute node in the cluster. In performing the rebalancing, the capacity-aware resource manager 109 evaluates the assignment of the resource to the second compute node based on the capacity consumption information for the resource and available capacity information for the second compute node. In some examples, the capacity-aware resource manager 109 further accounts for the cost of transferring the resource in determining whether to transfer the assignment of the resource and in the selection of the compute node to which the resource assignment is to be transferred. If the second compute node has sufficient capacity, the assignment of the resource to the second compute node is confirmed. On the other hand, if the capacity-aware resource manager 109 determines that the second compute node has insufficient capacity, the resource assignment to the second compute node is rejected.

In view of the disclosure above, various examples are set forth below. It should be noted that one or more features of an example, taken in isolation or combination, should be considered within the disclosure of this application.

Example 1. A system comprising: a compute cluster comprising multiple compute nodes, a compute node in the compute cluster comprising: at least one hardware processor; and at least one memory storing instructions that cause the at least one hardware processor to perform operations comprising: evaluating an assignment of a resource for a service to the compute node, the evaluating of the assignment comprising: determining one or more capacity consumption metrics associated with compute capacity consumed by the resource; determining one or more available capacity metrics associated with the compute node; and comparing the one or more capacity consumption metrics with the one or more available capacity metrics; and determining whether to confirm the assignment of the resource to the compute node based on the evaluating.

Example 2. The system of Example 1, wherein the operations comprise confirming the assignment of the resource to the compute node in response to determining that the one or more capacity consumption metrics associated with compute capacity consumed by the resource do not exceed the one or more available capacity metrics of the compute node.

Example 3. The system of any one or more of Examples 1 or 2, wherein the operations comprise rejecting the assignment of the resource to the compute node in response to determining that at least one capacity consumption metric associated with compute capacity consumed by the resource exceeds a corresponding available capacity metric of the compute node.

Example 4. The system of any one or more of Examples 1-3, wherein: the compute node is a first compute node in the compute cluster; and a second compute node in the compute cluster evaluates the assignment of the resource to the second compute node in the compute cluster based on the one or more capacity consumption metrics associated with compute capacity consumed by the resource and available capacity information associated with the second compute node.

Example 5. The system of any one or more of Examples 1-4, wherein the operations further comprise: receiving estimated capacity information for the resource from the service, the estimated capacity information comprising one or more estimated capacity consumption metrics, wherein the one or more capacity consumption metrics associated with compute capacity consumed by the resource are determined based on the estimated capacity information.

Example 6. The system of any one or more of Examples 1-5, wherein the operations further comprise: storing observed capacity information for the resource, wherein the one or more capacity consumption metrics associated with compute capacity consumed by the resource are determined based on the observed capacity information.

Example 7. The system of any one or more of Examples 1-6, wherein the one or more capacity consumption metrics associated with compute capacity consumed by the resource are determined based on a combination of observed capacity information and estimated capacity information, the observed capacity information comprising one or more observed compute capacity consumption metrics of the resource, the estimated capacity information comprising one or more estimated compute capacity consumption metrics.

Example 8. The system of any one or more of Examples 1-7, wherein the evaluating of the assignment of the resource for the service to the compute node is performed by the compute node based on locally stored capacity information.

Example 9. The system of any one or more of Examples 1-8, wherein: the one or more capacity consumption metrics comprise one or more of: an amount of storage space consumed, an amount of memory consumed, a number of threads consumed, CPU utilization, network bandwidth utilization, performed I/O operations per second, and a number of sockets used; and the one or more available capacity metrics comprise one or more of: an amount of available storage space, an amount of available memory, a number of spawnable computational threads, CPU capacity, available network bandwidth, performable I/O operations per second, and a number of available sockets.

Example 10. A method comprising: evaluating an assignment of a resource for a service to a compute node in a compute cluster, the evaluating of the assignment comprising: determining one or more capacity consumption metrics associated with compute capacity consumed by the resource; determining one or more available capacity metrics associated with the compute node; and comparing the one or more capacity consumption metrics with the one or more available capacity metrics; and determining whether to confirm the assignment of the resource to the compute node based on the evaluating.

Example 11. The method of Examples 10, further comprising confirming the assignment of the resource to the compute node in response to determining that the one or more capacity consumption metrics associated with compute capacity consumed by the resource do not exceed the one or more available capacity metrics of the compute node.

Example 12. The method of any one or more of Examples 10 or 11, further comprising rejecting the assignment of the resource to the compute node in response to determining that at least one capacity consumption metric associated with compute capacity consumed by the resource exceeds a corresponding available capacity metric of the compute node.

Example 13. The method of any one or more of Examples 10-12, wherein: the compute node is a first compute node in the compute cluster; and the method further comprises evaluating an assignment of the resource to a second compute node in the compute cluster based on the one or more capacity consumption metrics associated with compute capacity consumed by the resource and available capacity information associated with the second compute node.

Example 14. The method of any one or more of Examples 10-13, further comprising: receiving estimated capacity information for the resource from the service, the estimated capacity information comprising one or more estimated capacity consumption metrics, wherein the one or more capacity consumption metrics associated with compute capacity consumed by the resource are determined based on the estimated capacity information.

Example 15. The method of any one or more of Examples 10-14, further comprising: monitoring the compute capacity consumed by the resource; and storing observed capacity information for the resource based on the monitoring of the compute capacity consumed by the resource, wherein the one or more capacity consumption metrics associated with compute capacity consumed by the resource are determined based on the observed capacity information.

Example 16. The method of any one or more of Examples 10-15, wherein the one or more capacity consumption metrics associated with compute capacity consumed by the resource are determined based on a combination of observed capacity information and estimated capacity information, the observed capacity information comprising one or more observed compute capacity consumption metrics of the resource, the estimated capacity information comprising one or more estimated compute capacity consumption metrics.

Example 17. The method of any one or more of Examples 10-16, wherein the evaluating of the assignment of the resource for the service to the compute node is performed by the compute node based on locally stored capacity information.

Example 18. The method of any one or more of Examples 10-17, wherein: the compute node is a first compute node; and the evaluating of the assignment of the resource for the service to the first compute node is performed by a second compute node based on locally stored capacity information.

Example 19. The method of any one or more of Examples 10-18, further comprising: performing, by the second compute node, rebalancing of resource assignments among compute nodes in the compute cluster, the rebalancing comprising transferring the assignment of the resource from the first compute node to a third compute node.

Example 20. A computer-storage medium comprising instructions that, when executed by one or more processors of a machine, configure the machine to perform operations comprising: evaluating an assignment of a resource for a service to a compute node, the evaluating of the assignment comprising: determining one or more capacity consumption metrics associated with compute capacity consumed by the resource; determining one or more available capacity metrics associated with the compute node; and comparing the one or more capacity consumption metrics with the one or more available capacity metrics; and determining whether to confirm the assignment of the resource to the compute node based on the evaluating.

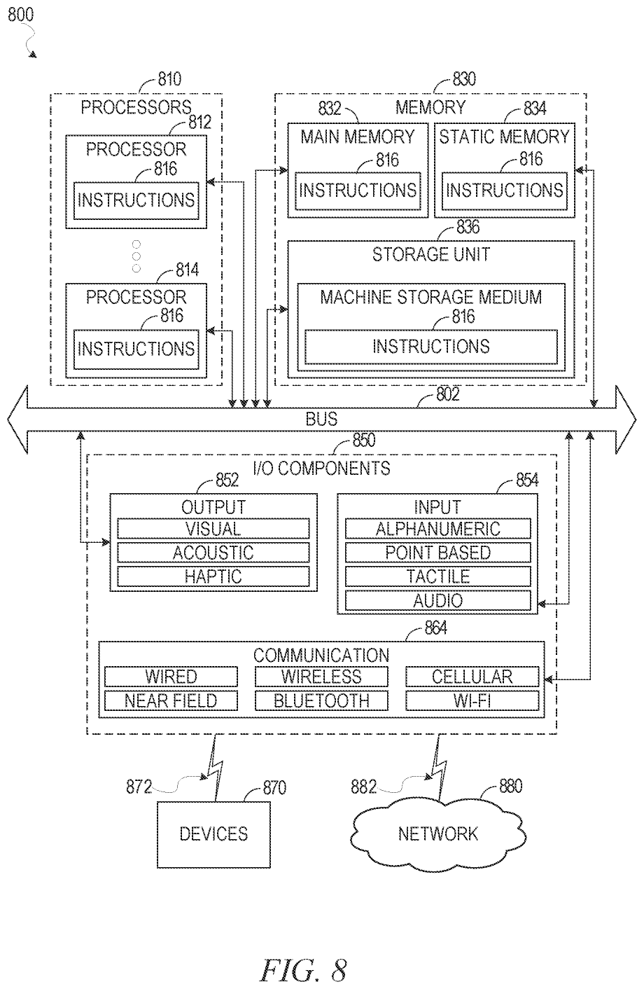

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., a software, a program, an application, an applet, an app, or other executable code) for causing the machine 800 to perform any one or more of the methodologies discussed herein may be executed. For example, the instructions 816 may cause the machine 800 to execute any one or more operations of the method 400. As another example, the instructions 816 may cause the machine 800 to implement any one or more portions of the functionality illustrated in any one of FIGS. 1-3. In this way, the instructions 816 transform a general, non-programmed machine into a particular machine that is specially configured to carry out any one of the described and illustrated functions of the cloud data platform 102 such as the compute service manager 108 (or a component thereof such as the capacity-aware resource manager 109) or an execution node of the execution platform 110.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and I/O components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 814 and a processor 812 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the compute service manager 108, the execution platform 110, and the devices 870 may include the data store 206 or any other computing device described herein as being in communication with the cloud data platform 102 or the data storage 104.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor implemented. For example, at least some of the operations of the method 400 may be performed by one or more processors. The performance of certain of the operations may be distributed among the one or more processors, not only residing within a single machine, but also deployed across a number of machines. In some example embodiments, the processor or processors may be in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
a compute cluster comprising multiple compute nodes, a compute node in the compute cluster comprising:
at least one hardware processor; and
at least one memory storing instructions that cause the at least one hardware processor to perform operations comprising:
evaluating an assignment of a resource for a service to the compute node, the evaluating of the assignment comprising:
determining one or more capacity consumption metrics associated with compute capacity consumed by the resource;
determining one or more available capacity metrics associated with the compute node; and
comparing the one or more capacity consumption metrics with the one or more available capacity metrics; and
determining whether to confirm the assignment of the resource to the compute node based on the evaluating.

2. The system of claim 1, wherein the operations comprise confirming the assignment of the resource to the compute node in response to determining that the one or more capacity consumption metrics associated with compute capacity consumed by the resource do not exceed the one or more available capacity metrics of the compute node.

3. The system of claim 1, wherein the operations comprise rejecting the assignment of the resource to the compute node in response to determining that at least one capacity consumption metric associated with compute capacity consumed by the resource exceeds a corresponding available capacity metric of the compute node.

4. The system of claim 3, wherein:
the compute node is a first compute node in the compute cluster; and
a second compute node in the compute cluster evaluates the assignment of the resource to the second compute node in the compute cluster based on the one or more capacity consumption metrics associated with compute capacity consumed by the resource and available capacity information associated with the second compute node.

5. The system of claim 1, wherein the operations further comprise:
receiving estimated capacity information for the resource from the service, the estimated capacity information comprising one or more estimated capacity consumption metrics, wherein the one or more capacity consumption metrics associated with compute capacity consumed by the resource are determined based on the estimated capacity information.

6. The system of claim 1, wherein the operations further comprise:
storing observed capacity information for the resource, wherein the one or more capacity consumption metrics associated with compute capacity consumed by the resource are determined based on the observed capacity information.

7. The system of claim 1, wherein the one or more capacity consumption metrics associated with compute capacity consumed by the resource are determined based on a combination of observed capacity information and estimated capacity information, the observed capacity information comprising one or more observed compute capacity consumption metrics of the resource, the estimated capacity information comprising one or more estimated compute capacity consumption metrics.

8. The system of claim 1, wherein the evaluating of the assignment of the resource for the service to the compute node is performed by the compute node based on locally stored capacity information.

9. The system of claim 1, wherein:
the one or more capacity consumption metrics comprise one or more of: an amount of storage space consumed, an amount of memory consumed, a number of threads consumed, CPU utilization, network bandwidth utilization, performed I/O operations per second, and a number of sockets used; and
the one or more available capacity metrics comprise one or more of: an amount of available storage space, an amount of available memory, a number of spawnable computational threads, CPU capacity, available network bandwidth, performable I/O operations per second, and a number of available sockets.

10. A method comprising:
evaluating an assignment of a resource for a service to a compute node in a compute cluster, the evaluating of the assignment comprising:
determining one or more capacity consumption metrics associated with compute capacity consumed by the resource;
determining one or more available capacity metrics associated with the compute node; and
comparing the one or more capacity consumption metrics with the one or more available capacity metrics; and
determining whether to confirm the assignment of the resource to the compute node based on the evaluating.

11. The method of claim 10, further comprising confirming the assignment of the resource to the compute node in response to determining that the one or more capacity consumption metrics associated with compute capacity consumed by the resource do not exceed the one or more available capacity metrics of the compute node.

12. The method of claim 10, further comprising rejecting the assignment of the resource to the compute node in response to determining that at least one capacity consumption metric associated with compute capacity consumed by the resource exceeds a corresponding available capacity metric of the compute node.

13. The method of claim 12, wherein:
the compute node is a first compute node in the compute cluster; and
the method further comprises evaluating an assignment of the resource to a second compute node in the compute cluster based on the one or more capacity consumption metrics associated with compute capacity consumed by the resource and available capacity information associated with the second compute node.

14. The method of claim 10, further comprising:
receiving estimated capacity information for the resource from the service, the estimated capacity information comprising one or more estimated capacity consumption metrics, wherein the one or more capacity consumption metrics associated with compute capacity consumed by the resource are determined based on the estimated capacity information.

15. The method of claim 10, further comprising:
monitoring the compute capacity consumed by the resource; and
storing observed capacity information for the resource based on the monitoring of the compute capacity consumed by the resource, wherein the one or more capacity consumption metrics associated with compute capacity consumed by the resource are determined based on the observed capacity information.

16. The method of claim 10, wherein the one or more capacity consumption metrics associated with compute capacity consumed by the resource are determined based on a combination of observed capacity information and estimated capacity information, the observed capacity information comprising one or more observed compute capacity consumption metrics of the resource, the estimated capacity information comprising one or more estimated compute capacity consumption metrics.

17. The method of claim 10, wherein the evaluating of the assignment of the resource for the service to the compute node is performed by the compute node based on locally stored capacity information.

18. The method of claim 10, wherein:
the compute node is a first compute node; and
the evaluating of the assignment of the resource for the service to the first compute node is performed by a second compute node based on locally stored capacity information.

19. The method of claim 18, further comprising:
performing, by the second compute node, rebalancing of resource assignments among compute nodes in the compute cluster, the rebalancing comprising transferring the assignment of the resource from the first compute node to a third compute node.

20. A computer-storage medium comprising instructions that, when executed by one or more processors of a machine, configure the machine to perform operations comprising:
evaluating an assignment of a resource for a service to a compute node, the evaluating of the assignment comprising:
determining one or more capacity consumption metrics associated with compute capacity consumed by the resource;
determining one or more available capacity metrics associated with the compute node; and
comparing the one or more capacity consumption metrics with the one or more available capacity metrics; and
determining whether to confirm the assignment of the resource to the compute node based on the evaluating.
